(19) United States
(12) Patent Application Publication
(10) Pub. No.: US 2005/0146730 A1
(43) Pub. Date: Jul. 7, 2005

(54) Coherent beam device for observing and measuring sample

(76) Inventors: Junji Endo, Saitama (JP); Chen Jun, Kanagawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/485,541

(22) PCT Filed: Aug. 2, 2002
(86) PCT No.: PCT/JP02/07851

(30) Foreign Application Priority Data
Aug. 2, 2001 (JP) 2001-234878

(51) Int. Cl. G01B 9/02

(52) U.S. Cl. 356/512

(57) ABSTRACT

In an interferometric device using a coherent beam and an image pickup camera, a protective glass for the detector surface is needed on the incident side of the pickup unit of the image pickup camera, and this gives rise to interference fringes which constitute noise. To solve this problem, a dustproof container is configured also to cover an imaging lens system arranged on the incident side of the pickup unit of the image pickup camera, and the pickup unit of the image pickup camera is arranged in this container. By assigning the function of the protective glass for the detector surface in the conventional configuration to the imaging lens system, the protective glass is made unnecessary.

### BACKGROUND OF THE INVENTION

The present invention relates to a device for observing or measuring the image of a sample by using a coherent beam, and more particularly to an interferometric device suitable for precise measurement of a coherent beam having been transmitted through or reflected by a sample.

Such a device according to the prior art would cause a laser beam transmitted or reflected by a sample to directly form an image in a camera by-using an imaging lens, as does the laser interferometer illustrated in Optical Shop Testing, Chapter 14 (Reference 1, J. E. Greivenkamp and J. H. Bruning, Chapter 14 “Phase Shifting Interferometer” in D. Malacara, ed., Optical Shop Testing, Second Edition, 1992, John Wiley &amp; Sons, Inc.) FIG. 14.2,(a)-(c). For instance in the example illustrated in FIG. 14.2(b), a beam emitted from a laser is enlarged by a beam expander into a plane wave having a large diameter, and divided into a beam transmitted through a first translucent mirror and a beam reflected by it. The transmitted beam, after having penetrating a sample, is altered upward in optical path by a reflector, reflected by a second translucent mirror, and is caused by an imaging lens to form an image on the detector surface of the camera. The beam reflected by the first translucent mirror is changed rightward in optical path by the reflector, transmitted through the second translucent mirror, and is caused by the imaging lens to form an image on the detector surface of the camera. On the detector surface-of-the camera, the beam which has been transmitted through the sample and undergone a change in wavefront from a plane (i.e. the object wave) and the plane wave to be referenced (i.e. the reference wave) interfere with each other to form an image consisting of interference fringes.

In this interference image is preserved the distribution of phases of the beam transmitted through the sample. This distribution of phases can be measured by one of several methods. The most basic one is a method by which the directions of the object wave and of the reference wave are brought to coincidence by controlling the inclination of the second translucent mirror to obtain the contour lines of the interference fringes of the object wave. In this case, as a contour line emerges every time the phase change reaches one wavelength, there is no problem when the phase change is substantial, but a phase change less than one wavelength needs to be discerned by the relative shade.

One of the methods for precise measurement of this less than one wavelength phase change is the phase shift method. By this method, the distribution of phases attributable to the sample preserved in the object wave is figured out by calculation from three or more interference images that have been taken in while controlling the relative phase-difference between the object wave and the reference wave. As shown in FIG. 14.2(b), one (usually on the reference beam side) of the reflectors is mounted on a movable stage driven by a piezo element and, if it finely moves in the direction of a line normal to the reflector for instance, though the phasic state of the object wave on the observation plane does not change, that of the reference wave on the observation plane does change because the optical path length varies, with the result that only the interference fringes move while the image of the sample remains unmoved. To take note of a certain point, with a variation of the reference wave in optical path length, the brightness of that point varies according to a sine curve. The quantity representing the starting position of this sine curve on a phasic basis is the phase of the object wave at that point. Therefore, by figuring out the sine curve at each point in the field of view, the distribution of phases attributable to the sample recorded on the object wave can be found.

Although the case described above refers to the transmission of a beam by the sample, an interferometer of the type using a beam reflected by the sample for measurement as shown in (a) and (c) of FIG. 14.2 in Reference 1 is based on exactly the same method and principle of measurement.

### SUMMARY OF THE INVENTION

In the interferometric method described in the foregoing section, an errorvin measurement could arise from:
1. Mechanical vibration propagating to the interferometer;
2. Oscillation of air on the optical path;
3. Accuracy of piezo driving;
4. Accuracy of the reflecting faces of the reflector and of the translucent mirror in planarity and thickness uniformity;
5. Stability of the frequency and strength of the laser;
6. Linearity of the camera with respect to any distortion of the picked-up image and the strength of the image output;
7. Accuracy of calculation;
8. Noise on the image signal line, or
9. Interference fringes due to front and back face reflections at the translucent mirror, the lens and the camera. Of these factors, those cited in 1, 3, 4, 8 and 9 are more influential than others, and particularly that in 9, which is based on the very principle of the method, is difficult to reduce.

The present invention has been attempted to reduce the influence of interference fringes due to front and back face reflections at the entrance surface of the detector part in the camera out of these adverse factors.

In front of the detector surface of a TV camera, if it is a camera tube, there is a glass for keeping vacuum and transmitting a beam or, if it is a solid state imaging camera, there is a protective film or a protective glass for protecting the surface of the image pickup element. As the protective film or the protective glass differs from air in refractive index, reflected beams arise on the incident face and the emitting face. A beam reflected by the emitting face gives rise to another reflected beam on the incident face, whose interference with the incident beam results in superposition of interference fringes on the observed/measured image. How a beam coming incident on such a protective glass is reflected is illustrated in FIGS. 1(a) and 1(b).

While a greater part of the incident beam represented by a solid line in FIG. 1(a) is transmitted through the incident face of a protective glass 100 as a transmitted beam 101, primary reflected beams arise on the incident face and the emitting face. The primary reflected beam on the emitting face is represented by a broken line 102, and the illustration of the primary reflected beam on the incident face is dispensed with because it is irrelevant to the explanation of the principle. This primary reflected beam 102 further gives rise to a secondary reflected beam 103 on the incident face. This is represented by a one-dot chain line. A greater part of the primary reflected beam 102 is transmitted, though not shown here. A greater part of the secondary reflected beam 103 is transmitted through the emitting face, again only partially reflected. The resultant tertiary reflected beam is not illustrated either. The three beams shown here are actually on the same line, but expressed at vertically different levels for the convenience of illustration.

Although the incident face and the emitting face of the protective glass 100 are depicted in FIG. 1(a) as exactly parallel planes, actually there are always infinitesimal unevenness. If they are exactly parallel planes, the brightness will be even all over as a result of interference between the transmitted beam 101 and the secondary reflected beam 103, but if there is unevenness, interference fringes will be formed. These states are illustrated in FIG. 1(b). Three vertical lines 115 on the left represent the wavefront of the incident beam 101, three vertical lines 116 on the right, the wavefront of the transmitted beam 101, and three corrugated lines 117, the wavefront of the secondary reflected beam 103. Variations in wavefront shape attributable to the refractive index-of the protective glass 100 are disregarded because they are simple. Further, the unevenness of only the incident face is considered, but variations of the uneven wavefront shape with the procession of the beam is disregarded.

As illustrated, the transmitted beam 101 is unaffected by any deformation of the wavefront and retains its plane wave form. The primary reflected beam 102, though it also is a plane wave because it is reflected by a plane, is not illustrated. The secondary reflected beam 103, as it is reflected by an uneven face, becomes a wavefront whose unevenness is double that of the incident face. The interference fringes resulting from interference between the transmitted beam 101 and the secondary reflected beam 103 are brighter where wavefronts overlap each other and darker where there is a lag of half interval between wavefronts. How this occurs is shown in FIG. 1(c).

This phenomenon can occur between the emitting face of the protective glass 100 and the photoelectric conversion film of the camera tube or the surface of the solid image pickup element. Thus in the conventional image observing or measuring device using a coherent beam, the glass or protective film in front of the detector surface of the camera gives rise to interference fringes, which deteriorate the image quality in the image observing device and also adversely affects the measuring accuracy of the interferometric device.

A number of solutions have already been proposed to this problem. For instance, the Japanese Patent Application Laid-open No. Hei 5-316284 “Image Pickup Device with Preventive Mechanism Against Noise of Interference Fringes” proposes to incline the protective glass, the Japanese Patent Application Laid-open No. Hei 8-145619 “Laser Interferometer”, to-shape the protective glass like a wedge, and the Japanese Patent Application Laid-open No. Hei 8-191418 “Image Pickup Device with Preventive Mechanism Against Noise of Interference Fringes”, a planoconvex lens as the protective glass, but all these ideas presuppose the indispensability of a protective-glass in front of the detector surface and consider the best way to provide one.

One of the causes for a deterioration in image quality or a drop in the measuring accuracy of interferometry in the conventional image observing or measuring device using a coherent beam is, as noted above, the interference fringes due to front and back face reflections of the transparent planar member, such as a protective glass, arranged in front of the image pickup device of the imaging apparatus. A conceivable way to prevent it is to coat the front and back faces of the transparent planar member against reflection, matched with the wavelength of the coherent beam to be used. However, though it is possible to reduce the reflections by 1 or 2%, this is insufficient for highly precise interferometry.

This problem can be intrinsically solved by doing away with the transparent planar member. In a camera tube type device, this member is difficult to remove because it constitutes part of a vacuum container, but in a solid image pickup element it can be done away with because the member is intended merely for surface protection. In this case, as the removal would result in exposure of the surface of the solid image pickup element, any smear or dust sticking to that surface would be difficult to remove, involving many problems including the fear of damaging the surface anew in a removing attempt. A possible way to eliminate this fear is to work out a solid state imaging camera in which only those parts integrated with the solid image pickup element can be simply replaced.

Alternatively, if the whole coherent beam device is housed in a dustproof-structured container, the possibility of dust or smear being stuck to the surface of the solid image pickup element can be substantially reduced. However, this structure would not only require a larger container but also involve awkwardness in the operation to replace the sample, making it necessary to open the container at least partly and entailing a greater fear of letting minute dust to enter into the container together with the sample.

It is therefore proposed to take note of the combination of the constituent elements of a coherent beam device and a solid state imaging camera, and to provide a dustproof-structured container in which are accommodated, out of optical components in positions not affecting the operation to replace the sample, such as the imaging lens and interference elements, the elements-whose positions are fixed in observing or measuring an image are arranged on the incident side, and components integrated with the solid state imaging camera or the solid image pickup element of the solid state imaging camera.

### BRIEF DESCRIPTION OF THE DRAWINGS

FIG. 1(a) illustrates how reflections on the front and back faces of a protective glass take place when the incident face and the emitting face of the protective glass of the focal plane of the image pickup camera are exactly parallel planes; FIG. 1(b), how interference fringes due to reflections on-the front and back-faces of the protective glass arise when the incident face and the emitting face of the protective glass of the detector surface of the image pickup camera are not exactly parallel planes; and FIG. 1(c), interference fringes arising from interference between a beam transmitted through the protective glass and a secondary reflected beam.

FIG. 2 shows a first preferred embodiment of the present invention.

FIG. 3 shows a second preferred embodiment of the invention.

FIG. 4 shows a third preferred embodiment of the invention.

FIG. 5 shows a fourth preferred embodiment of the invention.

### DESCRIPTION OF THE PREFERRED EMBODIMENT

### Embodiment I

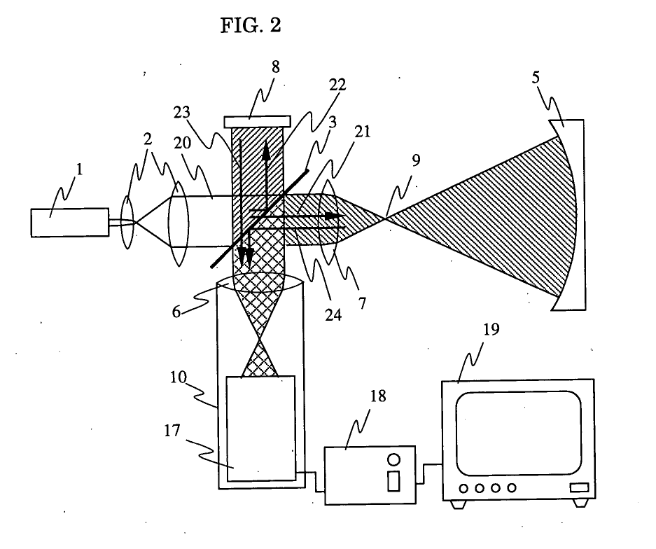

A first preferred embodiment of the invention is shown in FIG. 2. This interference optical system causes a reflected beam from a concave mirror and a reflected beam from a reference mirror to interfere with each other, and checks any distortion of the concave mirror from the shape of interference fringes. A laser beam 20 emitted from a laser 1 is shaped into a parallel radiating beam having a large diameter with a collimator lens system 2, and this beam is split by a beam splitter 3, which is a translucent mirror, into a transmitted beam 21 and a reflected beam 22. The reflected beam 22 is reflected by a highly planar reference surface 8 to become a reference beam 23 (the part hatched with leftward slopes) and, after being transmitted through the beam splitter 3, is projected by an imaging lens 6 on the detector surface of a solid state imaging camera 17. On the other hand, the transmitted beam 21 is turned into a divergent light centering on a focus 9 by a collective lens 9, and this divergent light irradiates a checked surface 5. The checked surface 5 is fabricated in a spherical face centering on the focus 9. If the checked surface 5 is an ideal spherical face, the part hatched with rightward slopes reflected by the checked surface 5 will constitute a spherical wave converging on the focus 9, and be converted by the collective lens 9 again into a parallel beam, i.e. a plane wave. This checked surface-reflected beam 24, after being reflected by the beam splitter 3, is projected by the imaging lens 6 on the detector surface of the solid state imaging camera 17. The solid state imaging camera 17 is supplied with power and controlled by a solid state imaging camera power source 18, and its image is displayed on an image observing monitor 19. In the overlapping part (the cross-hatched part) of the reference beam 23 and the checked surface-reflected beam 24, as-two plane waves overlap each other, there are formed interference fringes, and the image of the solid state imaging camera 17 consists of linear interference fringes. When the directions of the two plane waves are made identical by adjusting the inclination of the beam splitter 3, there is achieved a state of uniform brightness all over.

However, actually the checked surface 5 slightly deviates from a sphere on account of the limitation of working accuracy. Since the machining of a sphere is usually less precise than that of a plane, the deviation of the checked surface 5 from a sphere is greater than that of the reference surface 8 from an ideal plane. Therefore, the interference fringes arising from the interference between the reference beam 23, which can be deemed to be a plane wave, and the checked surface-reflected beam 24 deviating from a plane wave correspondingly to the deviation of the checked surface 5 from a-sphere are off a straight line according to the location and magnitude of the deviation of the checked surface 5 from a sphere, and it can be determined whether or not the checked surface 5 is within a certain standard range by bringing the directions of the two beams to coincidence.

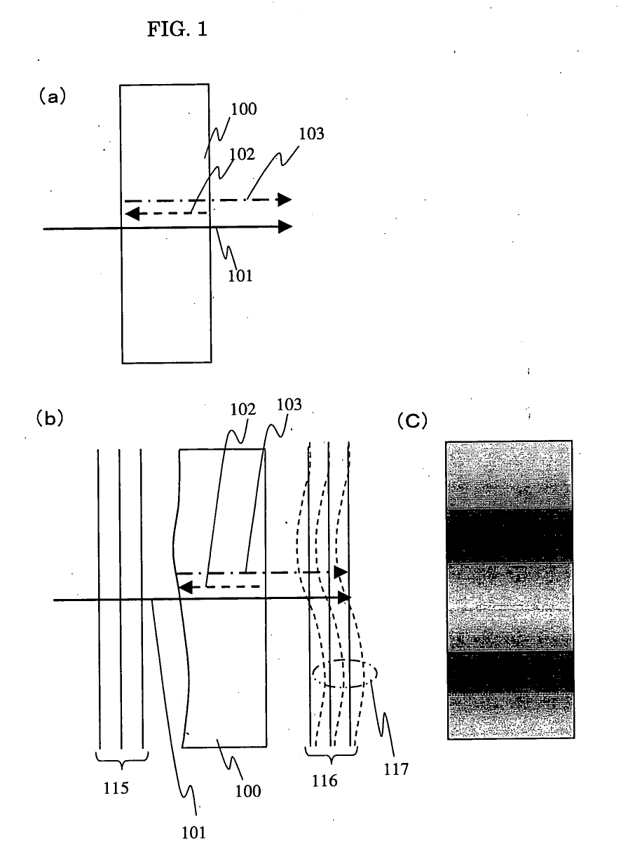

In a conventional interferometer, as a protective glass is adhered in front of the detector surface of the solid state imaging camera, interference fringes due to reflections on the front and back faces of the protective glass superpose over the measured image as described with reference to FIG. 1, and they cannot be distinguished by the distribution of shades due to the deviation of the checked surface 5 from a sphere, often posing obstacles to accurate checking. In view of this problem, for this embodiment of the invention, a solid state imaging camera with no protective glass in front of the detector surface has been produced, and the detector surface is positioned to be identical with the observation plane of the interferometric system. Since the absence of a protective glass exposes the detector surface to the risk of damage due to the adhesion of dust, the solid state imaging camera 17 is housed within a dustproof container 10 of which one end consists of the imaging lens 6. This has made it possible to do away with interference fringes due to reflections on the front and back faces of the protective-glass in the conventional configuration and to prevent the surface of the image pickup element from catching dust or being smeared. In this embodiment, the imaging lens 6, which would be one of the constituent parts of a conventional interferometer, is assigned the additional role to serve as the protective glass for the solid image pickup element.

### Embodiment II

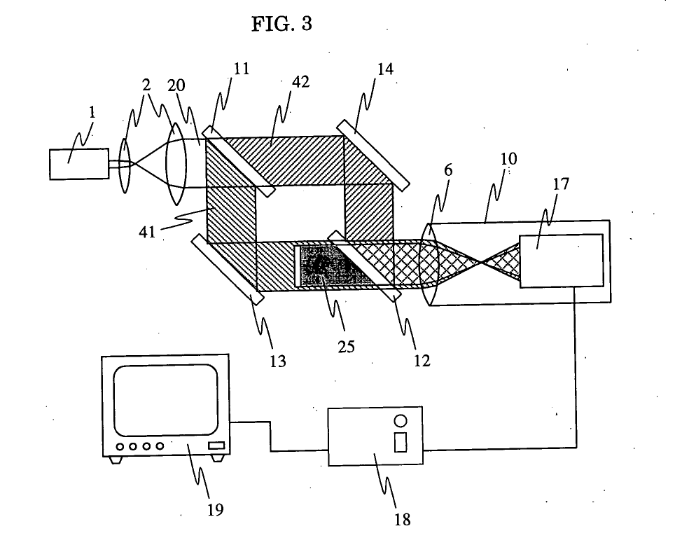

FIG. 3 shows a second preferred embodiment of the invention. This interference optical system is intended to cause a beam transmitted through a sample and a reference beam to interfere with each other, and to measure the distribution of refractive indices within the sample from the shape of interference fringes. The laser beam 20 emitted from the laser 1 is converted by the collimator lens system 2 into a parallel radiating beam 20 having a large diameter, and is split by a first translucent mirror 11 into a reflected beam 41 (the part hatched with rightward slopes) and a transmitted beam 42 (the part hatched with leftward slopes). The reflected beam 41 is reflected by a first reflector 13 to irradiate a sample 4. A sampled-transmitted beam 25 (the gray part) locally varied by the distribution of refractive indices within the sample is transmitted through a second translucent mirror 12, and is caused by the imaging lens 6 to form an image on the detector surface of the solid state imaging camera 17. The transmitted beam 42 is reflected by a second reflector 14, further reflected by the second translucent mirror 12, and is caused by the imaging lens 6 to form an image on the detector surface of the solid state imaging camera 17. In this case, as in the first preferred embodiment, highly planar elements are used as the first translucent mirror 11, the second translucent mirror 12, the first reflector 13 and the second reflector 14, the transmitted beam 42 is equivalent to the reference beam 23 in the first embodiment, which can be deemed to be a plane wave, the sample-transmitted beam 25 deviates from a plane wave only reflecting the refractive index within the sample 4, and these two beams interfere with each other (the cross-hatched part) to form interference fringes. When the directions of the two beams are brought to coincidence by adjusting the inclination of the second translucent mirror 12, there will emerge a distribution of shades corresponding to the quantity of phase variations attributable to the sample 4. This interference image is displayed on the image observing monitor 19 via the solid state imaging camera 17 and the solid state imaging camera power source.18 to enable the internal structure of the sample to be observed.

Since this embodiment of the invention, like the first embodiment, can also have the imaging lens 6, which could be a constituent part of a conventional interferometer, perform the additional role to serve as the protective glass for the solid image pickup element by housing the solid state imaging camera 17 within the dustproof container 10, there is no need to provide a protective glass in front of the detector surface of the solid state imaging camera, and it is free from the problem of superposition of interference fringes due to reflections on the front and back faces of the protective glass over the measured image.

### Embodiment III

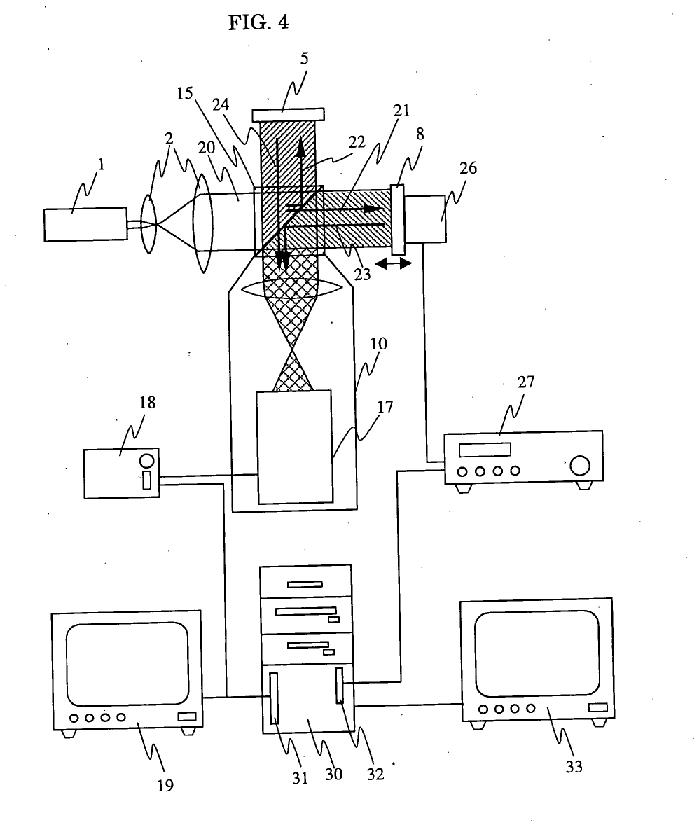

FIG. 4 shows a third preferred embodiment of the invention. This interference optical system is intended to apply a high precision interferometric method known as the phase shift method to cause a beam reflected by a checked plane and a reference beam to interfere with each other and thereby to measure the planarity of the checked plane. The laser beam 20 emitted from the laser 1 is shaped into a parallel beam 20 having a large diameter with the collimator lens system 2, and split by a cubic beam splitter 15 into a transmitted beam 21 (the part hatched with rightward slopes) and a reflected beam 22 (the part hatched with leftward slopes). The reflected beam 22 is reflected by the checked surface 5, transmitted through the cubic beam splitter 15 as the checked surface-reflected beam 24, and caused by the imaging lens 6 to form an image on the detector surface of the solid state imaging camera 17. The transmitted beam 21 is reflected by the reference surface 8, further reflected by the cubic beam splitter 15 as the reference beam 23, and caused by the imaging lens 6 to form an image on the detector surface of the solid state imaging camera 17. As the reference surface 8 is highly planar, the reference beam 23 becomes a beam which can be deemed to be a plane wave, and interferes with the checked surface-reflected beam 24 from the checked surface 5 to form interference fringes (the cross-hatched part). When the directions of the two beams are brought to coincidence by adjusting the inclination of the cubic beam splitter 15, there will emerge a distribution of shades corresponding to the quantity of phase variations according to the planarity of the checked surface 5 to enable this planarity of the checked surface 5 to be evaluated.

In this embodiment, since the solid state imaging camera 17 is housed within the dustproof container 10 of which one end consists of the emitting face of the cubic beam splitter 15, no protective glass is required, and the configuration ensures the absence of interference fringes due to reflections on the front and back faces of the protective glass. Further the possibility of the imaging lens 6 to catch dust is substantially reduced by its being housed within the dustproof container 10, making possible more precise measurement.

The difference of this embodiment from embodiments I and III consists in the use of the phase shift method, whose basics are described below. The relative phase-difference between a reference beam and a checked beam, or the checked surface-reflected beam 24 in this embodiment, is varied at a time by 1/M (M is a positive number of not smaller than 3) of the wavelength of the laser beam that is used, and the two-dimensional phase distribution recorded on the checked beam is figured out by calculation each time from the M interference images that have been taken in. To realize this process, the reference surface 8 is fixed to a piezo-driven stage 26, and is shifted by a prescribed infinitesimal quantity from a control/analysis computer 30 to an equipment control board 32 in the direction of an arrow in the drawing to enable the optical path length of the reference beam 23 to be varied. An image from the solid state imaging camera 17 is displayed on the image observing monitor 19 via the solid state imaging camera power source 18, at the same time taken into the control/analysis computer 30 via an image take-in board 31, and recorded in an internal memory or some other storage device. Computation software based on the phase shift method is built into the control/analysis computer 30, and the distribution of the checked surface-reflected beam 24 figured out from the interference image that has been taken in is displayed on a computer-serving monitor 33.

The interferometric system using the phase shift method permits far more accurate measurement than the usual interferometer proposed as the first or second embodiment. According to the prior art, however, there is a heavy constraint on the accuracy of measurement because phase variations due to interference fringes resulting from reflections on the front and back faces of the protective glass of the image pickup camera are superposed over the measured results and they cannot be separated from each other. In this embodiment, as the solid state imaging camera 17 having no protective glass for its detector surface is used as the image pickup camera to prevent interference fringes due to reflections on the front and back faces from occurring and housed together with the imaging lens 6 in the dustproof container 10 of which one end consists of the cubic beam splitter 15, the aforementioned constraint on the accuracy of measurement is substantially eased.

It goes without saying-that, even if some other fine adjustment stage, such as a stepping motor-driven stage, is used here for finely moving the reference surface 8 in place of the piezo-driven stage 26 or the image observing monitor 19 and the computer-serving monitor 33 are used in combination, similar effects and functions can be achieved. Of even if the configuration does not use the phase shift method, as interference fringes due to reflections on the front and back faces of the protective glass of the solid state imaging camera 17 do not arise, the accuracy will be higher than what the conventional method can provide as is the case with the first two embodiments.

In an interferometer of this type, if the cubic beam splitter 15 is turned by an infinitesimal degree around an axis normal to the face of the drawing instead of finely shifting the reference surface 8 in the direction of the optical axis, the phase shift method can be implemented. In this case, since the imaging lens 6 and the solid state imaging camera 17 need to be fixed to the interferometer during the measurement process, the structure would be such that one end of the dustproof container 10 is the imaging lens 6 as in the first two embodiments.

### Embodiment IV

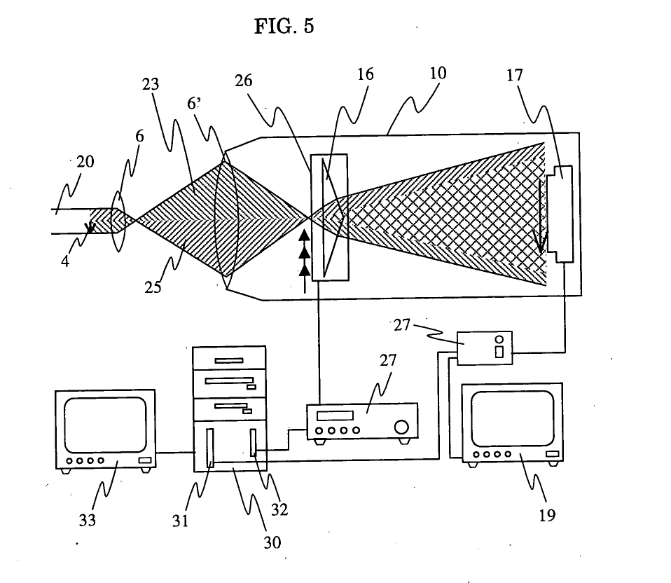

A fourth preferred embodiment of the present invention is shown in FIG. 5. This interference optical system is another example of measuring the distribution of refractive indices within a transmissive sample by using the phase shift method. In this drawing, neither the laser nor the collimator lens system is shown. The parallel laser beam 20 irradiates the sample 4 placed on one side of the optical path, or in the lower half of the drawing. The beam on the side where the sample is present (the part hatched with rightward slopes) serving as the sample-transmitted beam 25 and that on the side where the sample is absent (the part hatched with leftward slopes) serving as the reference beam 23, they are magnified at two stages by the imaging lens 6 and a magnifying lens 6′, and form an image on the detector surface of the solid state imaging camera 17. Between the magnifying-lens 6′ and the solid state imaging camera 17, there is provided a prismatic beam splitter 16 mounted on the piezo-driven stage 26. The sample-transmitted beam 25 and the reference beam 23 are caused by the prismatic beam splitter 16 to overlap each other as represented by the cross-hatched part in the drawing, and form an image consisting of a group of interference fringes off a straight line according to the distribution of refractive indices within the sample.

To implement the phase shift method, the piezo-driven stage 26 mounted with the prismatic beam splitter 16 is shifted by an prescribed infinitesimal quantity from the control/analysis computer 30 via the equipment control board 32 as indicated by an arrow in the drawing. If, for instance, it is finely shifted upward, the phase of the transmitted beam 25 is advanced uniformly as this beam passes a thinner part of the prismatic beam splitter 16 while the phase of the reference beam 23 is delayed uniformly as this beam passes a thicker part. Therefore, interference fringes deviate upward, but M interference images are taken into the control/analysis computer 30 via the image take-in board 31 while having the prismatic beam splitter 16 finely shift the piezo-driven stage 26 by 1/M (M is a positive number of not smaller than 3) of interference fringes at a time, and recorded in an internal memory or some other storage device. As in the third embodiment, the distribution of the sampled-transmitted beam 25 is figured out from the interference image that has been taken in by using computation software built into the control/analysis computer 30, and is displayed on a computer-serving monitor 33.

In this embodiment, since the solid state imaging camera 17, together with the piezo-driven stage 26 on which the prismatic beam splitter 16 is mounted, is housed within the dustproof container 10 of which one end consists of the magnifying lens 6′, no protective glass is required and accordingly interference fringes due to reflections on the front and back faces of the protective glass can be prevented from arising. Furthermore in this embodiment, not only the detector surface of the solid state imaging camera 17 but also the prismatic beam splitter 16 and one face of the magnifying lens 6′ can be prevented from catching smear. Although the prismatic beam splitter 16 shifts during the measurement process, as the whole piezo-driven stage 26 is housed in the dustproof container 10, it is sufficient to lead only the electrical wiring of the piezo-driven stage 26 into the dustproof container 10 in a dustproof way, and shifting of the prismatic beam splitter 16 poses no problem. Also, this embodiment can be further developed into a dustproof container 10 of which one end consists of the imaging lens 6, one face of the imaging lens 6 and the magnifying lens 6′ can be prevented from catching dust, resulting in an even higher level of effectiveness.

In any of the embodiments described above, reflections on the front and back faces of the imaging lens give rise to interference fringes. They are intrinsically difficult to eliminate, and there is no other alternative than to reduce them by anti-reflection coating.

The device for observing or measuring an image by using a coherent beam according to the present invention provides the advantage of improving the accuracy of observation and measurement as it can eliminate interference fringes reflections on the front and back faces of the image pickup element and further can prevent the image pickup element or some of other optical components from catching dust or smear by housing them in a dustproof container.

1. A coherent beam device for observing or measuring a sample wherein a coherent beam source, a checked sample, an optical path for letting pass an object wave resulting from the wavefront variation of a beam from said coherent beam source from a plane by said checked sample, another optical path for letting pass a reference wave which references the beam from said coherent beam source, an imaging lens system for forming on an observation plane an image consisting of interference fringes by causing said object wave and said reference wave to interfere with each other, a solid state imaging camera so placed that the surface of its exposed image pickup element come to the position of observation plane, and the solid state imaging camera and one periphery of the elements of said imaging lens system are enclosed in a sealed container.

2. The coherent beam device, as set forth in claim 1, wherein said one periphery of the elements of the imaging lens system is the periphery of the imaging lens of said imaging lens system.

3. The coherent beam device, as set forth in claim 1, wherein said imaging lens system has a cubic beam splitter and one periphery of the elements of said imaging lens system is the periphery of one face of said cubic beam splitter or consists of four faces in contact with that one face.

4. The coherent beam device, as set forth in any of claims 1 through 3, wherein the object wave resulting from the wavefront variation of the beam from said coherent beam source by said checked sample is the result of transmission of said beam by said checked sample.

5. The coherent beam device, as set forth in any of claims 1 through 3; wherein the object wave resulting from the wavefront variation of the beam from said coherent beam source by said checked sample is the result of reflection of said beam by said checked sample.

6. The coherent beam device, as set forth in claim 5, wherein said object wave as the result of reflection by said checked sample is generated by a reflective face made finely shiftable in the direction of the beam from said coherent beam source for the purpose of image analysis by a phase shift method.

7. A coherent beam device for observing or measuring a sample wherein a coherent beam source, a checked sample, an optical path for letting pass an object wave resulting from the wavefront variation of a beam from said coherent beam source from a plane by being transmitted through said checked sample, another optical path for letting pass a reference wave which references the beam from said coherent beam source, a magnifying lens for magnifying said object wave and said reference wave, a prismatic beam splitter for forming on an observation plane an image consisting of interference fringes by causing said object wave having been transmitted through the magnifying lens and said reference wave to interfere with each other, a solid state imaging camera so placed that the surface of its exposed image pickup element come to the position of the observation plane, and the solid state imaging camera and the periphery of said magnifying lens are enclosed in a sealed container.

8. The coherent beam device, as set forth in claim 7, wherein said prismatic beam splitter is made finely shiftable in the direction orthogonal to the beam from said coherent beam source for the purpose of image analysis by a phase shift method.
